(19) United States
(12) Patent Application Publication
(10) Pub. No.: US 2024/0153349 A1
(43) Pub. Date: May 9, 2024

(54) PEER-TO-PEER WAGERING

(71) Applicant: BRAGGING RIGHTS, INC., Cleveland, OH (US)

(72) Inventors: Cory Finding, Broadview Heights, OH (US); Scott Davis, Avon, OH (US); Joseph Romano, Bay Village, OH (US)

(21) Appl. No.: 18/548,996

(22) PCT Filed: Mar. 7, 2022
(86) PCT No.: PCT/US2022/019119

§ 371 Date: Sep. 5, 2023

Related U.S. Application Data
(60) Provisional application No. 63/157,122, filed on Mar. 5, 2021.

(51) Int. Cl. G07F 17/32; A63F 13/798; A63F 13/86; H04L 9/00

(52) U.S. Cl. CPC G07F 17/3255; A63F 13/798; A63F 13/86; G07F 17/3279; G07F 17/3288; H04L 9/50

(57) ABSTRACT

Peer-to-peer wagering is provided to customers matched over an interactive gaming network. A customer can match to another customer to play a gaming match of a video game over a gaming server or network. The two customers can access a wager portal with which to place a wager on the outcome of their gaming match. The customers agree to a wager over the gaming match via the wager portal. The wager includes a wager amount. The customers can each provide the wager amount to the wager portal. The customers can proceed with playing the gaming match. The wager portal monitors the match outcome by connecting to the gaming server to determine the outcome. The wager portal determines which customer won the gaming match and therefore won the wager. The wager portal transfers the wager amounts to the winning customer or customer account.

### CROSS REFERENCE TO RELATED APPLICATIONS

This application claims the benefit of U.S. Provisional Patent Application Ser. No. 63/151,122, entitled “PEER-TO-PEER WAGERING” filed on Mar. 5, 2021. The entirety of the above-noted application is incorporated by reference herein.

### BACKGROUND

Online gaming matches labeled as e-sports are commonplace amongst video game players. Players can match online or in person with other players for a gaming match decided within a video game. The e-sports world has gained momentum with the advancement of personal computer gaming and advanced gaming systems. Today, the interconnectivity of society permits peer vs. peer or person vs. person gaming amongst strangers. At the same time, wagering between peers, and/or the like has become more prevalent in society, in particular wagering between peers, and/or the like on e-sports.

### BRIEF SUMMARY OF THE DESCRIPTION

The following presents a simplified summary to provide a basic understanding of some aspects of the disclosed subject matter. This summary is not an extensive overview of the innovation. It is not intended to identify key/critical elements of the innovation or to delineate the scope of the disclosed subject matter. Its sole purpose is to present some concepts in a simplified form as a prelude to the more detailed description that is presented later.

Peer-to-peer wagering is provided to customers matched over a gaming network. A customer can match to another customer to play a gaming match of a video game over a gaming server or network. The two customers can access a wager portal with which to place a wager on the outcome of their gaming match. The customers agree to a wager over the gaming match via the wager portal. The wager includes a wager amount or some other prize. The customers can each provide the wager amount to the wager portal. The customers can proceed with playing the gaming match. The wager portal monitors the match outcome by connecting to the gaming server to determine the outcome. The wager portal determines which customer won the gaming match and therefore won the wager. The wager portal transfers the wager amounts to the winning customer or customer account.

In aspects, the subject disclosure provides substantial benefits in terms of peer-to-peer competition and/or wagering. One advantage resides in an automated process for online gaming match wagering. Another advantage resides in secured wagering between individuals online. Yet another advantage resides in rankings between peers of a digital game and rewards for rankings achievements. It should be appreciated that the individuals may be any of friends, strangers, acquaintances, relatives, and the like, generally referred to herein as parties, customers, or individuals.

In aspects, the subject innovation and disclosure advantageously provides for a method, system, and platform having security (such as an ERC-20 (Ethereum Request for Comments 20) token used to wager which is secure and immutable); validation (such as an API (Application Programming Interface) data integration with third-party gaming platforms to validate wager outcomes); in-app gamification (such as, competitive integrated ranking system to provide e-sports sponsorships, incentives, and the like); subscription-based platform to increase player incentives, rewards, payouts, and the like; increased product stability.

In aspects, the subject innovation and disclosure advantageously provides for a method, system, and platform for users/individuals to access (with or without subscription) to then connect with other individuals through direct request or by a search for other individuals, for competition. Additionally, the individual(s) may purchase or otherwise acquire tokens such as in the form of crypto-currency for wagering in a peer-to-peer environment, such as but not limited to 2v2, 3v3, 4v4, 5v5, etc., or any combinations thereof, best of series game play, and/or winner-take-all types of wagers. In embodiments, direct data from third party gaming providers, in combination with information obtained by the instant innovative platform via gameplay, contributes to a ranking system for individuals to earn winnings, rewards, incentives, and the like.

To the accomplishment of the foregoing and related ends, certain illustrative aspects of the subject matter are described herein in connection with the following description and the annexed drawings. These aspects are indicative of but a few of the various ways in which the subject matter can be practiced, all of which are intended to be within the scope of the disclosed subject matter. The subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example system diagram for peer-to-peer gaming/wagering according to aspects herein.

FIG. 2 illustrates an example system diagram for peer-to-peer gaming/wagering according to aspects herein

FIG. 3 illustrates an example component diagram for peer-to-peer gaming/wagering.

FIG. 4 illustrates a method for peer-to-peer gaming/wagering.

FIG. 5 illustrates a computing environment where one or more of the provisions set forth herein can be implemented, according to some embodiments.

### DETAILED DESCRIPTION

Peer-to-peer wagering is provided to customers matched over a gaming network, including but not limited to via a decentralized peer-to-peer network. A customer can match to another customer to play a gaming match of a video game over a gaming server or network. The two customers can access a wager portal with which to place a wager on the outcome of their gaming match. The customers agree to a wager over the gaming match via the wager portal. The wager includes a wager amount. The customers can each provide the wager amount to the wager portal. The customers can proceed with playing the gaming match. The wager portal monitors the match outcome by connecting to the gaming server to determine the outcome. The wager portal determines which customer won the gaming match and therefore won the wager. The wager portal transfers the wager amounts to the winning customer or customer account.

While the innovation is described in a context of “wagering,” it is to be understood that this description is but one embodiment. Other embodiments would be directed to non-monetary gaming where points, chips, rewards or the like can be achieved in a pure entertainment scenario. These alternative embodiments are to be included within the scope of this disclosure and claims appended hereto without departing from the spirit and/or scope of the innovation.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

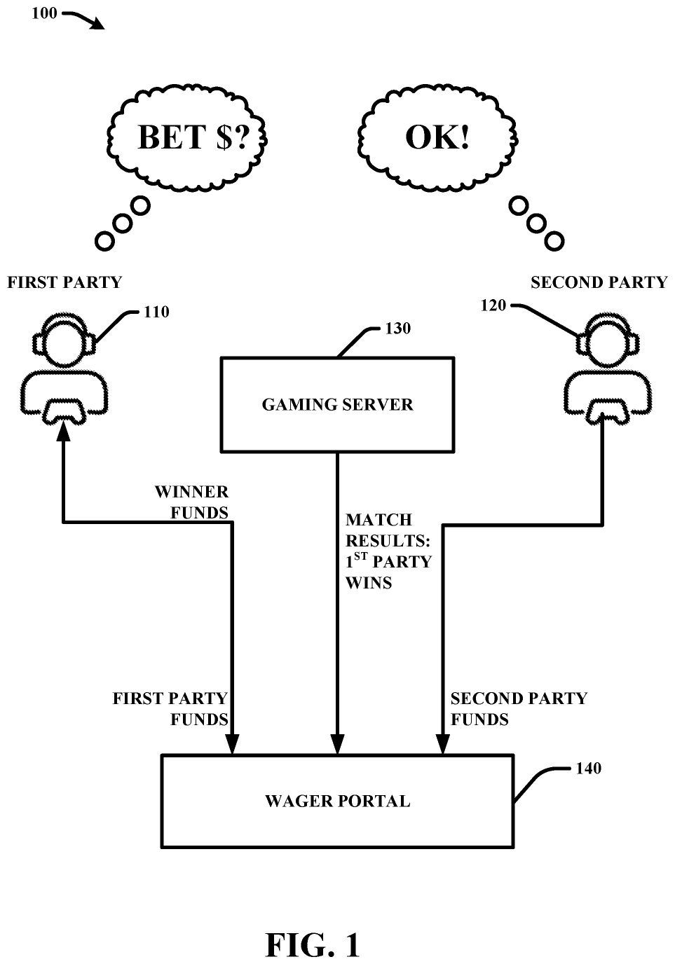

FIG. 1 illustrates a system 100 for peer-to-peer wagering. A first party 110 and a second party 120 can each be connected or associated with a gaming server 130. The gaming server 130 hosts gaming matches of a video game, a digital game, or games. The gaming server 130 can connect parties via a server to play against one another in competitive matches of the video game. The gaming server 130 can broker a digital match between the first party 110 and a second party 120. In some embodiments, the gaming server 130 can be associated with a video game system or device. In other embodiments, the gaming server 130 can be associated with a user device (e.g., a smartphone, tablet, virtual reality headset, and/or the like), an operating system, a video game, an in person game, and/or the like.

The gaming server 130 can provide access to accounts for players of the digital video game. The gaming server 130 provides the first party 110 and/or the second party 120 a registration page or option to provide and/or track party information such as financial accounts, user identification, gameplay statistics, social media accounts, associate parties, and/or the like.

The gaming server 130 can interface with a wager portal 140. The wager portal 140 can associate a party account with the wager portal 140 with a party account with the gaming server 130. The wager portal 140 can send and receive information from the gaming server 130. For example, the wager portal 140 can receive party information to create a wager profile for the first party 110 and/or the second party 120. The wager portal 140 can track points or funds associated with a wager profile of the first party 110 and/or the second party 120.

In some embodiments, the wager portal 140 and/or the gaming server 130 can provide or open a communication portal between the first party 110 and/or the second party 120. The communication portal can be text based, voice based, video based, and/or the like. The first party 110 and the second party 120 can converse via the communication portal. The communication portal can connect the first party 110 and the second party 120 via voice over internet protocol, cellular network, internet, social media messaging, direct message, text message, and/or the like.

The first party 110 and the second party 120 can agree to wager on the digital match via the communication portal over the wager portal 140. It should be appreciated that more than two gaming devices/individuals are also contemplated as being within the scope of the present innovation. However, for purposes of brevity and simplicity, the details of the present innovation are described and discussed herein as having two gaming devices/individuals (i.e., peer-to-peer). In some embodiments, the wager portal 140 can match the first party 110 and the second party 120 for purposes of wagering. The wager portal 140 can match a first party 110 to a second party 120 that is at or near the same level of skill in the digital video game(s). In other embodiments, the first party 110 can find the second party 120 via a profile search over the wager portal 140. In some embodiments, the wager portal 140 can match a first party 110 to a second party 120 that is at or near the same level of skill in different digital video games that are similar. For example, the first party 110 has a level of skill in a first war based game and the second party 120 has a similar level of skill but in a second war based game. The wager portal 140 can match the parties for wagering on a match in the first war based game, the second war based game, or a third war based game that neither party has yet established a skill level (e.g. a newly or recently released digital video game).

The wager portal 140 can receive a wager from the first party 110 and/or the second party 120 regarding the outcome of a digital match. The wager portal 140 can receive wager details such as wager amount, video game identification, match identification, match type, and/or the like. In some embodiments, the wager portal 140 can automatically determine the wager details from a conversation analysis of a conversation between the first party 110 and the second party 120. The wager portal 140 can generate and send a notification to the first party 110 and/or the second party 120 for a confirmation of the wager details. The first party 110 and/or the second party 120 can provide a response or an opt-in for the wager. The notification can be sent to a party device, a gaming device, via the gaming server 130, and/or the like to the first party 110 and/or the second party 120.

The first party 110 and/or the second party 120 can provide funds to the wager portal 140 regarding the wager. In some embodiments, the first party 110 and/or the second party 120 purchases a unique currency within the wager portal 140 that is specific to the wager portal 140. For example, a digital currency, points, distributed ledger, block chain, decentralized secure transaction ledger, and/or the like such that the currency exists within the wager portal 140 for wagering between parties. In some embodiments, the first party 110 and/or the second party 120 subscribes to the wager portal 140 for access the wager portal 140 for wagering. In some embodiments, the digital currency is associated with a party as the owner of the digital currency in a distributed ledger, such as an ETHEREIUM® based coin or token, or another comparable token including, for example, a decentralized ERC token. The association is updated upon transfer of some or all of the digital currency as ownership changes respectively after a match outcome or wager. In embodiments, each user or party is advantageously associated with a digital wallet configured to store a value of the cryptocurrency tokens and/or for conducting at least one transaction via the network, including the blockchain-based network. It should be understood that digital wallets provide for the storage of digital currency and/or the conducting of transactions quickly with little or no additional transaction fees.

The wager portal 140 can interface with the gaming server 130 upon receiving or brokering a wager between the two parties. The wager portal 140 can interface with the gaming server 130 to monitor the digital match and determine the outcome automatically from the gaming server 130. The outcome of the match can be an outright winner, higher scoring party, a winning third party, and/or the like. The wager between the two parties will include the different outcomes associated with each party to determine who will win the wager.

When the wager portal 140 determines the outcome of the digital match from the gaming server, the wager portal 140 determines which party is entitled to the wager amount. The wager portal 140 transfers the funds that were held in escrow to the winning party. The wager portal 140 can transfer the funds to the winning party's account within the wager portal 140. In some embodiments, the wager portal 140 can transfer the funds to the winning party's financial account or any other account as desired by the individual party.

The wager portal 140 can determine rankings for the first party 110 and/or the second party 120. The rankings can display the level of parties wagering in relation to other customers or users of the wager portal 140. The wager portal 140 can utilize the rankings to match up parties for future wagers, matches, and/or the like. In some embodiments, the wager portal 140 determines rankings based on quality of play within the video game. The wager portal 140 can call, obtain, retrieve, and/or receive play data from the gaming server 130. The wager portal 140 can continuously or periodically pull, retrieve, or obtain the data from the gaming server 130. The play data can be data about the first party 110 and/or second party 120 regarding how they (or quality of) play within the game. The play data can be metrics regarding the quality of play within the digital video game. For example, the play data for a football based video game can be touchdowns, yards, touchdown rate, passes defended while controlling the defender, points score, points against, and/or the like. The wager portal 140 can analyze the play data to compute or determine a ranking of the individual player, e.g. the first party 110 and/or the second party 120. In some embodiments, the rankings can be for an individual game. In other embodiments, a composite ranking of a player across multiple video games can be determine. In another embodiment, a cumulative rankings can be computed and/or updated according to the outcome of the wager. The cumulative rankings include all players associated with the wager portal 140 that are playing the digital video game via the gaming server 130.

In some embodiments, players or parties on the platform or wager portal 140 can be organized into a tiered ranking system. The tiered ranking system can provide different ranking tiers or levels that use player data such that the players can progress through to higher tiers as their rankings increase. In some embodiments, the tiers become progressively more difficult to achieve. In some embodiments, players that achieve the highest or high tiers (e.g. a top party in the rankings) are offered sponsorship opportunities, rewards, extra funds paid out, and/or the like. In other embodiments, the tiers and/or rankings affect which players a party can wager against using the wager portal 140. In some embodiments, the tiers and/or rankings affect the amount of the digital currency that can be wagered by a party within a time period or on a single match.

In some embodiments, the wager portal 140 can record a video or audio/visual data of the digital match. The wager portal 140 can capture video of the digital match from the gaming server 130. The wager portal 140 can provide a playback of the digital match to the first party 110 and/or the second party 120. In other embodiments, the wager portal 140 can provide playback to a viewer (e.g. a third party). In some embodiments, the wager portal 140 may provide a playback of the video in exchange for a payment from the viewer. The playback may be accessed via the wager portal 140 and/or the gaming server 130 in exchange for the payment from the viewer. In some embodiments, the wager portal 140 may provide a live playback option of wagered matches. The wager portal 140 can select wagered on matches from a plurality of matches based on business rules. For example, highly wagered valued matches (e.g. wagers above a threshold amount of funds) or matches between highly ranked parties may be automatically selected for a live playback (e.g., “livestream”). The live playback may be provided to other parties or users of the wager portal 140 in real time or near real time. In some embodiments, the live playback may be viewable or watched in exchange for a payment from viewers. The live playback may be advertised via the wager portal 140 to other parties or users of the wager portal 140.

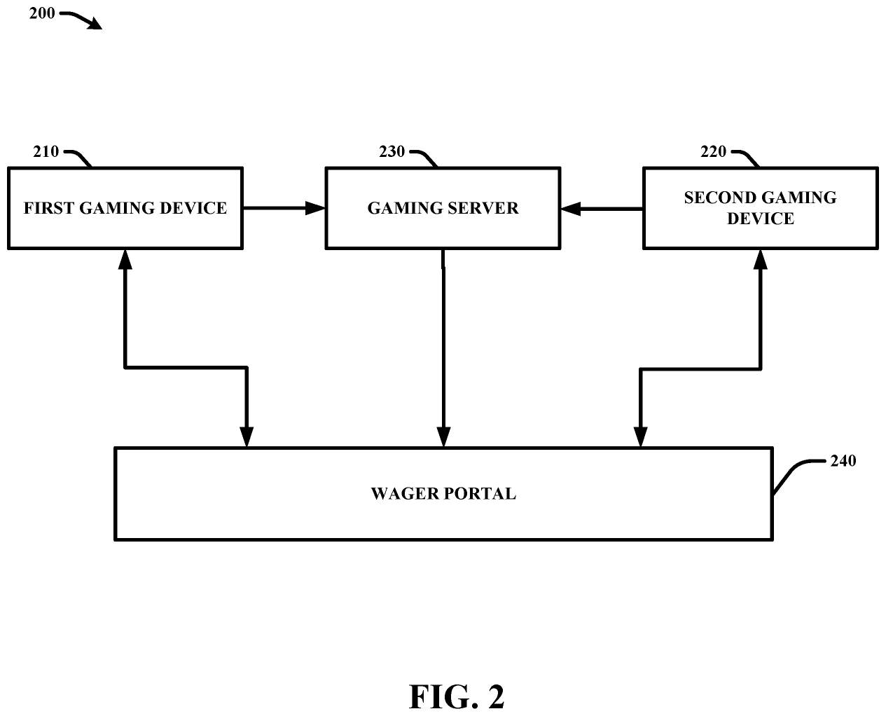

FIG. 2 illustrates an example system 200 for peer to peer wagering according to aspects herein. The system 200 includes a first gaming device 210, a second gaming device 220, a gaming server 230, and a wager portal 240. The gaming server 230 hosts gaming matches of a video game or games. The gaming server 230 can connect parties via one or more servers to play against one another in competitive matches of the video game. The gaming server 230 can broker a digital match between a first gaming device 210 associated with a first party or individual and a second gaming device 220 associated with a second party or individual. The first party and the second party can agree to wager on the digital match. It should be appreciated that more than two gaming devices/individuals are also contemplated as being within the scope of the present innovation. However, for purposes of brevity and simplicity, the details of the present innovation are described and discussed herein as having two gaming devices/individuals (i.e., peer-to-peer).

The first party and the second party can wager on the outcome of the digital match between them using a wager portal 240. The wager portal 240 can be a website, mobile device application, application residing on a gaming device, integrated interface, and/or the like. In some embodiments, the wager portal 240 may be an electronic e-sports wagering platform system. The wager portal 240 can connect the first party and the second party such that they can wager between each other over digital matches. The wager portal 240 can receive funds from the first party and/or the second party. In some embodiments, the first party and/or the second party purchases a unique currency within the wager portal 240 that is specific to the wager portal 240. For example, a digital currency, points, distributed ledger based funds, block chain funds, decentralized secure transaction ledger, and/or the like such that the currency exists within the wager portal 240 for wagering between parties. In some embodiments, the first party and/or the second party subscribe to the wager portal 240 for access the wager portal 240 for wagering. In some embodiments, the digital currency is associated with a party as the owner of the digital currency in a distributed ledger, such as an ETHEREUM® based coin or token, or any other comparable token including a decentralized (Ethereum Request for Comment) ERC token. The association is updated upon transfer of some or all of the digital currency as ownership changes respectively after a wager. In embodiments, each user or party is advantageously associated with a digital wallet configured to store a value of the cryptocurrency tokens and/or for conducting at least one transaction via the network, including the blockchain-based network. It should be understood that digital wallets provide for the storage of digital currency and/or the conducting of transactions quickly with little or no additional transaction fees.

The wager portal 240 can interface with the first gaming device 210, the second gaming device 220, the gaming server 230, the first party, the second party, and/or the like. The wager portal 240 can interface with the gaming server 230 upon receiving or brokering a wager between the two parties. The wager portal 240 can interface with the gaming server 230 to monitor the digital match and determine the outcome automatically from the gaming server 230. The outcome of the match can be an outright winner, higher scoring party, a winning third party, and/or the like. The wager between the two parties will include the different outcomes associated with each party to determine who will win the wager.

When the wager portal 240 determines the outcome of the digital match from the gaming server, the wager portal 240 determines which party is entitled to the wager amount. The wager portal 240 transfers the funds that were held in escrow to the winning party. The wager portal 240 can transfer the funds to the winning party's account within the wager portal 240. In some embodiments, the wager portal 240 can transfer the funds to the winning party's financial account or any other account as desired by the individual.

The wager portal 240 can determine rankings for the first party and/or the second party. The rankings can display the level of parties wagering in relation to all customers or users of the wager portal 240. The wager portal 240 can utilize the rankings to match up parties for future wagers, matches, and/or the like.

In some embodiments, the wager portal 240 determines rankings based on quality of play within the video game. The wager portal 240 can call, obtain, retrieve, and/or receive play data from the gaming server 230. The wager portal 240 can continuously or periodically pull, retrieve, or obtain the data from the gaming server 230. The play data can be data about the first party and/or second party regarding how they (or quality of) play within the game. For example, the play data for a war based video game can be kill count, headshots, grenade kills, flags captured, time between deaths, time between kills, sprees, time controlling an area, and/or the like. The wager portal 240 can analyze the play data to determine a ranking of the individual player, i.e. the first party and/or the second party. In some embodiments, the rankings can be for an individual game. In other embodiments, a composite ranking of a player across multiple video games can be determine.

In some embodiments, players on the platform or wager portal 240 can be organized into a tiered ranking system. The tiered ranking system can provide different ranking tiers or levels that use player data such that the players can progress through to higher tiers as their rankings increase. In some embodiments, the tiers become progressively more difficult to achieve. In some embodiments, players that achieve the highest or high tiers are offered sponsorship opportunities, rewards, and/or the like. In other embodiments, the tiers and/or rankings affect which players a party can wager against using the wager portal 240. In some embodiments, the tiers and/or rankings affect the amount of the digital currency that can be wagered by a party within a time period or on a single match.

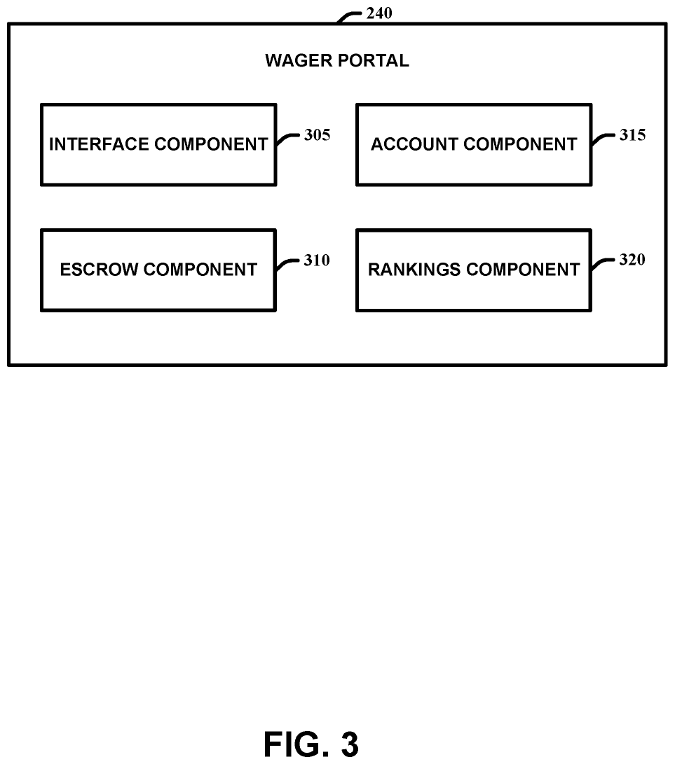

FIG. 3 illustrates an example component diagram of a wager portal 240. The wager portal 240 includes an interface component 305. The interface component 305 can interface with the first gaming device 210, the second gaming device 220, the gaming server 230, the first party, the second party, and/or the like. The interface component 305 can interface with the gaming server 230 upon receiving or brokering a wager between the two parties. The interface component 305 can interface with the gaming server 230 to monitor the digital match and determine the outcome automatically from the gaming server 230. The outcome of the match can be an outright winner, higher scoring party, a winning third party, and/or the like. The wager between the two parties can include the different outcomes associated with each party to determine who will win the wager. In some embodiments, the interface component 305 can record gameplay from the gaming server 230 to determine outcomes.

The wager portal includes an escrow component 310. The escrow component 310 can receive the funds or currency from the first party and/or the second party in the amount that is included in the wager. The escrow component 310 can receive funds from the first party and/or the second party. In some embodiments, the first party and/or the second party purchases a unique currency within the wager portal 240 that is specific to the wager portal 240. For example, a digital currency, points, distributed ledger, block chain, and/or the like such that the currency exists within the wager portal 240 for wagering between parties. In some embodiments, the digital currency is a cryptocurrency such as but not limited to an ETHEREUM® cryptocurrency, such as an (Ethereum Request for Comment) token such as an ERC-20 token or an ERC-1404 token. The escrow component 310 can use the digital currency for the wager and directly deduct the digital currency from the party's accounts. The escrow component 310 holds the digital currency until the digital match is completed and the outcome is determined to provide the parties' secure knowledge that the digital currency is safe and legitimate.

In some embodiments, the escrow component 310 can receive conventional funds from the first party and/or second party. The escrow component 310 can generate a digital currency or multiple digital coins equal to the amount of the wager total on an ad hoc basis. The escrow component 310 holds the digital currency until the digital match is completed and the outcome is determined to provide the parties' secure knowledge that the digital currency is safe and legitimate.

The wager portal 240 includes an account component 315. When the interface component 305 determines the outcome of the digital match from the gaming server, an account component 315 determines which party is entitled to the wager amount. The account component 315 transfers the funds that were held in escrow at the escrow component 310 to the winning party. In some embodiments, the account component 315 can transfer the funds to the winning party's account within the wager portal 240. In some embodiments, the account component 315 can transfer the funds to the winning party's financial account, or any other account as desired by the individual.

The wager portal 240 includes a rankings component 320. The rankings component 320 can determine rankings for the first party and/or the second party. The rankings can display the level of parties wagering in relation to all customers or users of the wager portal 240. The rankings component 320 can utilize the rankings to match up parties for future wagers, matches, and/or the like. In some embodiments, the rankings component 320 provides sponsorship opportunities to highly ranked parties or professional garners. In some embodiments, the rankings component 320 generates a composite rankings of all users across a plurality of games and platforms.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull control model. The components may also interact with one or more other components not specifically described herein for sake of brevity, but known by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Among other things, such components can automate certain mechanisms or processes performed thereby to make portions of the systems and methods more adaptive as well as efficient and intelligent. By way of example, and not limitation, such mechanisms can be utilized by the wager portal 240.

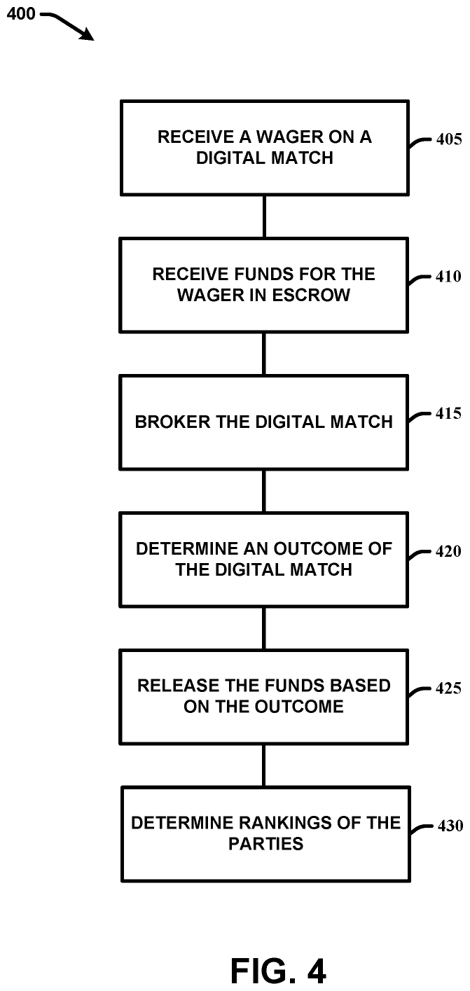

In view of the exemplary systems described above, methods that may be implemented in accordance with the disclosed subject matter will be better appreciated with reference to flow chart diagram of FIG. 4. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 4 illustrates a method 400 for peer-to-peer wagering. At 405, a wager on a digital match is received. The wager can indicate a first party, a second party, a wager amount, digital match information (e.g. specific game, time, match type, participants, and/or the like), public or private wager, and/or the like. At 410, funds for the wager are received. The funds can be conventional currency or unique currency such as a digital currency, points, distributed ledger, block chain, and/or the like such that the currency exists within the wager portal 240 for wagering between parties.

At 415, the digital match is brokered between a first party and a second party. The digital match can be brokered or organized between the parties on a gaming server 230 between a first gaming device 210 associated with the first party and a second gaming device 220 associated with the second party. Once the match is brokered, the digital match can be played between the parties. At 420, the outcome of the digital match is determined. The outcome can be in favor of one of the first party or the second party. The outcome can be retrieved or received by the wager portal 240 from the gaming server 230. In some embodiments, the outcome is retrieved by the wager portal 240 using an application programming interface (API) call and response.

At 425, the funds are released to the winning party of the wager. The winning party is the party that correctly won the digital match. The funds are released to the winning party's financial account or account within the wager portal 240. At 430, rankings of the parties are determined. The rankings can be determined initially or updated based on the outcome of the digital match. The rankings reflect skill in wagering and/or skill in the video game in comparison to other players and/or parties on the wager portal 140.

The innovation described herein can provide a real-time subscription based wager platform that allows parties or customers to utilize a gaming experience for wagers. The platform provides a value algorithm and tokenization solutions around data sets assembled from social gaming systems. A ranking system can be used to present wagers, a temporary position of ascendancy in a closely contested rivalry (e.g., “bragging rights,”), winnings, and rankings between parties on the platform. Ranking users based on successes in the e-sport gaming universe (e.g., digital matches) and within the platform, parties will be able to leverage their skills by not only wagering funds such as crypto-tokens in e-sports matches, but by also earning reward winnings from achieving a high “rank” within the platform.

Crypto-tokens (e.g., a digital currency) provide users to value their skills using an online wagering platform. The ranking system of valuing users can also measure and score users' relative value, from home users to professionals, sponsored matches, pay-per-view or any gaming e-sport match or competition. In some embodiments, the platform interfaces with social media of users to drive the value proposition and bragging potential.

In some embodiments, the platform can facilitate creating a game play streaming service for digital matches for wagering and watching wagered game play on digital matches. In some embodiments, the platform can create pay-per-view events for streaming. In some embodiments, the platform can create professional gaming network to facilitate sponsorships. In some embodiments, the platform can provide mentorship, training, or video classes for games.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

To provide a context for the disclosed subject matter, FIG. 4 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

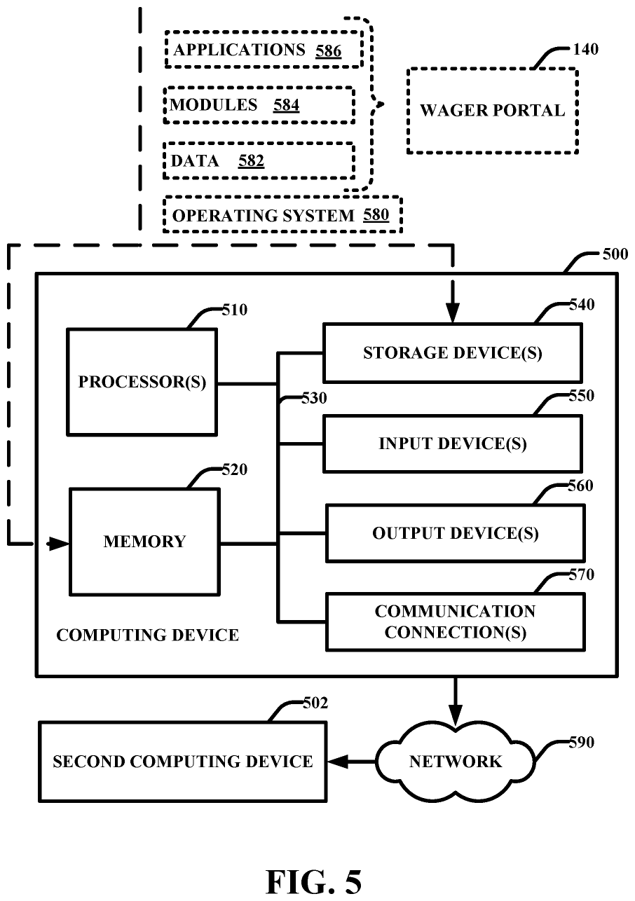

With reference to FIG. 5, illustrated is an example computing device 500 (e.g., desktop, laptop, tablet, watch, server, hand-held, programmable consumer or industrial electronics, set-top box, game system, compute node . . . ). The computing device 500 includes one or more processor(s) 510, memory 520, system bus 530, storage device(s) 540, input device(s) 550, output device(s) 560, and communications connection(s) 570. The system bus 530 communicatively couples at least the above system constituents. However, the computing device 500, in its simplest form, can include one or more processors 510 coupled to memory 520, wherein the one or more processors 510 execute various computer executable actions, instructions, and or components stored in the memory 520.

The processor(s) 510 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 510 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 510 can be a graphics processor unit (GPU) that performs calculations with respect to digital image processing and computer graphics.

The computing device 500 can include or otherwise interact with a variety of computer-readable media to facilitate control of the computing device to implement one or more aspects of the disclosed subject matter. The computer-readable media can be any available media that accessible to the computing device 500 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 500. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 520 and storage device(s) 540 are examples of computer-readable storage media. Depending on the configuration and type of computing device, the memory 520 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 500, such as during start-up, can be stored in nonvolatile memory, while volatile memory can act as external cache memory to facilitate processing by the processor(s) 510, among other things.

The storage device(s) 540 include removable/non-removable, volatile/non-volatile storage media for storage of vast amounts of data relative to the memory 520. For example, storage device(s) 540 include, but are not limited to, one or more devices such as a magnetic or optical disk drive, floppy disk drive, flash memory, solid-state drive, or memory stick.

Memory 520 and storage device(s) 540 can include, or have stored therein, operating system 580, one or more applications 586, one or more program modules 584, and data 582. The operating system 580 acts to control and allocate resources of the computing device 500. Applications 586 include one or both of system and application software and can exploit management of resources by the operating system 580 through program modules 584 and data 582 stored in the memory 520 and/or storage device(s) 540 to perform one or more actions. Accordingly, applications 586 can turn a general-purpose computer 500 into a specialized machine in accordance with the logic provided thereby.

All or portions of the disclosed subject matter can be implemented using standard programming and/or engineering techniques to produce software, firmware, hardware, or any combination thereof to control the computing device 500 to realize the disclosed functionality. By way of example and not limitation, all or portions of the wager portal 140 can be, or form part of, the application 586, and include one or more modules 584 and data 582 stored in memory and/or storage device(s) 540 whose functionality can be realized when executed by one or more processor(s) 510.

In accordance with one particular embodiment, the processor(s) 510 can correspond to a system on a chip (SOC) or like architecture including, or in other words integrating, both hardware and software on a single integrated circuit substrate. Here, the processor(s) 510 can include one or more processors as well as memory at least similar to the processor(s) 510 and memory 520, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the wager portal 140 and/or functionality associated therewith can be embedded within hardware in a SOC architecture.

The input device(s) 550 and output device(s) 560 can be communicatively coupled to the computing device 500. By way of example, the input device(s) 550 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 560, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 550 and output device(s) 560 can be connected to the computing device 500 by way of wired connection (e.g., bus), wireless connection (e.g., Wi-Fi, Bluetooth . . . ), or a combination thereof.

The computing device 500 can also include communication connection(s) 570 to enable communication with at least a second computing device 502 by means of a network 590. The communication connection(s) 570 can include wired or wireless communication mechanisms to support network communication. The network 590 can correspond to a local area network (LAN) or a wide area network (WAN) such as the Internet. The second computing device 502 can be another processor-based device with which the computing device 500 can interact. For example, the computing device 500 can correspond to a server that executes functionality of wager portal 140, and the second computing device 502 can be a user device that communications and interacts with the computing device 500.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
brokering a digital match between a first party and a second party, wherein the brokering includes a wager between the first party and the second party over an outcome of the digital match;
receiving funds from at least one of the first party or the second party;
determining the outcome of the digital match in favor of one of the first party or the second party; and
releasing funds to either the first party or the second party based on the outcome.

2. The method of claim 1, further comprising:
determining a ranking of at least one of the first party and the second party based on the outcome of the digital match, wherein the ranking is computed based on one or more metrics of the digital match, and wherein the ranking reflects a level of skill of the first party or the second party.

3. The method of claim 2, further comprising:
conducting the digital match via a digital video game; and
updating composite rankings, wherein the composite rankings are determined across a plurality of digital video games.

4. The method of claim 1, further comprising:
determining a ranking of at least one of the first party and the second party based the outcome of the wager.

5. The method of claim 1, further comprising:
updating a cumulative rankings according to the outcome of the wager, wherein the cumulative rankings include a plurality of parties;
determining a top party according to the cumulative rankings; and
providing a reward to the top party, wherein the reward is one of a sponsorship or extra funds.

6. The method of claim 1, further comprising:
maintaining the funds in escrow until the outcome of the digital match is determined.

7. The method of claim 1, comprising:
wherein the funds are block chain funds or distributed ledger based funds.

8. The method of claim 1, further comprising:
recording a video of the digital match; and
providing playback of the video of the digital match, wherein playback is accessed for a payment from a viewer.

9. The method of claim 1, further comprising:
interfacing with a gaming server to determine the outcome of the digital match, wherein the outcome of the digital match is one of an outright winner or a higher scoring party.

10. An electronic e-sports wagering platform system, comprising:
brokering a digital match between at least two parties, wherein the brokering includes a wager between at least one first party and at least one second party over an outcome of the digital match;
receiving funds from at least one of the first party or the second party;
determining the outcome of the digital match in favor of one of the first party or the second party;
releasing funds to either the first party or the second party based on the outcome; and
determining rankings of at least one of the first party and the second party based on at least one of the outcome of the digital match and the wager.

11. The electronic e-sports wagering platform system of claim 10, further comprising:
determining a ranking of at least one of the first party and the second party based on the outcome of the digital match, wherein the rankings are computed based on one or more metrics of the digital match, and wherein the rankings reflect a level of skill of the first party or the second party.

12. The electronic e-sports wagering platform system of claim 11, further comprising:
conducting the digital match via a digital video game; and
updating composite rankings, wherein the composite rankings are determined across a plurality of digital video games.

13. The electronic e-sports wagering platform system of claim 10, further comprising:
determining a ranking of at least one of the first party and the second party based the outcome of the wager.

14. The electronic e-sports wagering platform system of claim 10, further comprising:
updating a cumulative rankings according to the outcome of the wager, wherein the cumulative rankings include a plurality of parties;
determining a top party according to the cumulative rankings; and
providing a reward to the top party, wherein the reward is one of a sponsorship or extra funds.

15. The electronic e-sports wagering platform system of claim 10, comprising:
maintaining the funds in escrow until the outcome of the digital match is determined.

16. The electronic e-sports wagering platform system of claim 10, comprising:
wherein the funds are block chain funds or distributed ledger based funds.

17. The electronic e-sports wagering platform system of claim 10, further comprising:
recording a video of the digital match; and
providing playback of the video of the digital match, wherein playback is accessed for a payment from a viewer.

18. The electronic e-sports wagering platform system of claim 10, further comprising:
interfacing with a gaming server to determine the outcome of the digital match, wherein the outcome of the digital match is one of an outright winner or a higher scoring party.

19. A method, comprising:
receiving a wager between at least one first party and at least one second party over an outcome of a digital match;
receiving funds from at least one of the first party or the second party;
determining the outcome of the digital match in favor of one of the first party or the second party;
releasing funds to either the first party or the second party based on an outcome; and
determining rankings of at least one of the first party and the second party based on at least one of the outcome of the digital match and the wager.

20. The method of claim 19, comprising:
wherein the funds are held in escrow until the outcome of the digital match is determined.
